(19) United States
(12) Patent Application Publication
(10) Pub. No.: US 2001/0019265 A1
(43) Pub. Date: Sep. 6, 2001

(54) Magnetic resonance imaging system and recording medium

(76) Inventor: Yoshihiro Matsushima, Tokyo (JP)

Correspondence Address: MOONRAY KOJIMA, BOX 627, WILLIAMSTOWN, MA, 01267, US

(21) Appl. No.: 09/779,292

(22) Filed: Feb. 8, 2001

(30) Foreign Application Priority Data
Feb. 9, 2000 (JP) 2000-31660

(51) Int. Cl. G01V 3/00

(52) U.S. Cl. 324/307; 324/309

(57) ABSTRACT

When a frame rate for magnetic resonance imaging is operated with a view toward implementing a magnetic resonance imaging system capable of adjusting the frame rate, a condition for acquiring a magnetic resonance signal is adjusted according to its operation.

### BACKGROUND OF THE INVENTION

The present invention relates to a magnetic resonance imaging system and a recording medium, and particularly to a magnetic resonance imaging system which performs real time shooting or imaging, and a recording medium having recorded therein a program for causing a computer to implement such a imaging function.

In a magnetic resonance imaging (MRI) system, a target to be shot or imaged is carried in an internal bore of a magnet system, i.e., a bore or space in which a static magnetic field is formed. A gradient magnetic field and a high-frequency magnetic field are applied to produce a magnetic resonance signal within the target. A tomogram is produced (reconstructed) based on its received signal. When the target is pricked while the tomogram of an affected part is being observed, or when a joint placed during bending exercises is imaged or shot, for example, magnetic resonance imaging or shooting in real time is carried out.

In the mere matter of the real time, however, its frame rate ranges from a fraction of ultrasonic imaging or shooting to about several tens fractions thereof, and time resolution is not necessarily high as an actual state. There maybe cases where it is desired to suitably adjust or control a frame rate for imaging according to the situation of an affected part or the like. However, a magnetic resonance imaging system capable of performing such an adjustment has not yet appeared.

### SUMMARY OF THE INVENTION

Therefore, an object of the present invention is to implement a magnetic resonance imaging system capable of adjusting a frame rate, and a recording medium which records therein a program for allowing a computer to execute such an imaging function.

(1) The invention according to one aspect for solving the above problems is a magnetic resonance imaging system comprising signal acquiring means for acquiring a magnetic resonance signal, image generating means for generating an image, based on the magnetic resonance signal, operating means for controlling a frame rate of the image, and adjusting means for controlling a signal acquiring condition of the signal acquiring means according to the frame rate.

In the invention according to this aspect, a signal acquiring condition of signal acquiring means is adjusted according to the control of a frame rate. Thus, a magnetic resonance imaging system is implemented which performs shooting or imaging at a variable frame rate.

(2) The invention according to another aspect for solving the above problems is the magnetic resonance imaging system described in (1), wherein the signal acquiring condition is the number of times that a magnetic resonance signal for the same view is acquired.

In the invention according to this aspect, the number of times that a magnetic resonance signal for the same view is acquired according to the control of a frame rate. Thus, a magnetic resonance imaging system is implemented which performs imaging at a variable frame rate.

(3) The invention according to a further aspect for solving the above problems is the magnetic resonance imaging system described in (1), wherein the signal acquiring condition is the number of views for acquiring a magnetic resonance signal.

In the invention according to this aspect, the number of views for acquiring a magnetic resonance signal according to the control of a frame rate. Thus, a magnetic resonance imaging system is implemented which performs imaging at a variable frame rate.

(4) The invention according to a still further aspect for solving the above problems is the magnetic resonance imaging system described in (1), wherein the signal acquiring condition is a cycle period of a pulse sequence for acquiring a magnetic resonance signal.

In the invention according to this aspect, a cycle period of a pulse sequence for acquiring a magnetic resonance signal is adjusted according to the control of a frame rate. Thus, a magnetic resonance imaging system is implemented which performs imaging at a variable frame rate.

(5) The invention according to a still further aspect for solving the above problems is the magnetic resonance imaging system described in (1), wherein the signal acquiring condition is an echo time for a magnetic resonance signal.

In the invention according to this aspect, an echo time for a magnetic resonance signal is adjusted according to the control of a frame rate. Thus, a magnetic resonance imaging system is implemented which performs imaging at a variable frame rate.

(6) The invention according to a still further aspect for solving the above problems is the magnetic resonance imaging system described in (1), wherein the signal acquiring condition is the size of a single central area at the time that a k space is partitioned into the single central area and a plurality of peripheral areas and data is updated in the central area with frequency higher than the peripheral areas.

In the invention according to this aspect, the size of a single central area at the time that a k space is partitioned into the single central area and a plurality of peripheral areas and magnetic resonance signals are collected in the central area with frequency higher than the peripheral areas, is adjusted according to the control of a frame rate. Thus, a magnetic resonance imaging system is implemented which performs imaging at a variable frame rate.

(7) The invention according to a still further aspect for solving the above problems is the magnetic resonance imaging system described in (1), wherein the signal acquiring condition is the partitioned number of peripheral areas at the time that a k space is partitioned into a single central area and a plurality of peripheral areas and data is updated in the central area with frequency higher than the peripheral areas.

In the invention according to this aspect, the partitioned number of peripheral areas at the time that a k space is partitioned into a single central area and a plurality of peripheral areas and magnetic resonance signals are collected in the central area with frequency higher than the peripheral areas, is adjusted according to the control of a frame rate. Thus, a magnetic resonance imaging system is implemented which conducts imaging at a variable frame rate.

(8) The invention according to a still further aspect for solving the above problems is the magnetic resonance imaging system described in (1), wherein the signal acquiring condition is the number of turnovers of a trajectory in a k space and the number of turns thereof at the time that a magnetic resonance signal is acquired according to a pulse sequence for echo planar/imaging.

In the invention according to this aspect, the number of turnovers of a trajectory in a k space and the number of turns thereof at the time that a magnetic resonance signal is acquired according to a pulse sequence for echo planar/imaging, is adjusted according to the control of a frame rate. Thus, a magnetic resonance imaging system is implemented which performs imaging at a variable frame rate.

(9) The invention according to a still further aspect for solving the above problems is a recording medium having recorded therein programs for causing a computer to execute a signal acquiring function for acquiring a magnetic resonance signal, an image generating function for generating an image, based on the magnetic resonance signal, an operating function for controlling a frame rate of the image, and an adjusting function for controlling a signal acquiring condition for the signal acquiring function according to the frame rate, in such a manner that the programs are readable by the computer.

In the invention according to this aspect, a program recorded in a recording medium controls a signal acquiring condition of signal acquiring means according to the control of a frame rate. Thus, magnetic resonance imaging at a variable frame rate is implemented.

(10) The invention according to a still further aspect for solving the above problems is the recording medium described in (9), wherein the signal acquiring condition is the number of times that a magnetic resonance signal for the same view is acquired.

In the invention according to this aspect, a program recorded in a recording medium adjusts the number of times that a magnetic resonance signal for the same view is acquired, according to the control of a frame rate. Thus, magnetic resonance imaging at a variable frame rate is implemented.

(11) The invention according to a still further aspect for solving the above problems is the recording medium described in (9), wherein the signal acquiring condition is the number of views for acquiring a magnetic resonance signal.

In the invention according to this aspect, a program recorded in a recording medium adjusts the number of views for acquiring a magnetic resonance signal, according to the control of a frame rate. Thus, magnetic resonance imaging at a variable frame rate is implemented.

(12) The invention according to a still further aspect for solving the above problems is the recording medium described in (9), wherein the signal acquiring condition is a cycle period of a pulse sequence for acquiring a magnetic resonance signal.

In the invention according to this aspect, a program recorded in a recording medium adjusts a cycle period of a pulse sequence for acquiring a magnetic resonance signal, according to the control of a frame rate. Thus, magnetic resonance imaging at a variable frame rate is implemented.

(13) The invention according to a still further aspect for solving the above problems is the recording medium described in (9), wherein the signal acquiring condition is an echo time for a magnetic resonance signal.

In the invention according to this aspect, a program recorded in a recording medium adjusts an echo time for a magnetic resonance signal according to the control of a frame rate. Thus, magnetic resonance imaging at a variable frame rate is implemented.

(14) The invention according to a still further aspect for solving the above problems is the recording medium described in (9), wherein the signal acquiring condition is the size of a single central area at the time that a k space is partitioned into the single central area and a plurality of peripheral areas and data is updated in the central area with frequency higher than the peripheral areas.

In the invention according to this aspect, a program recorded in a recording medium controls the size of a single central area at the time that a k space is partitioned into the single central area and a plurality of peripheral areas and magnetic resonance signals are collected in the central area with frequency higher than the peripheral areas, according to the control of a frame rate. Thus, magnetic resonance imaging at a variable frame rate is implemented.

(15) The invention according to a still further aspect for solving the above problems is the recording medium described in (9), wherein the signal acquiring condition is the partitioned number of peripheral areas at the time that a k space is partitioned into a single central area and a plurality of peripheral areas and data is updated in the central area with frequency higher than the peripheral areas.

In the invention according to this aspect, a program recorded in a recording medium adjusts the partitioned number of peripheral areas at the time that a k space is partitioned into a single central area and a plurality of peripheral areas and magnetic resonance signals are collected in the central area with frequency higher than the peripheral areas, according to the control of a frame rate. Thus, magnetic resonance imaging at a variable frame rate is implemented.

(16) The invention according to a still further aspect for solving the above problems is the recording medium described in (9), wherein the signal acquiring condition is the number of turnovers of a trajectory in a k space and the number of turns thereof at the time that a magnetic resonance signal is acquired according to a pulse sequence for echo planar/imaging.

In the invention according to this aspect, a program recorded in a recording medium adjusts the number of turnovers of a trajectory in a k space and the number of turns thereof at the time that a magnetic resonance signal is acquired according to a pulse sequence for echo planar/imaging, according to the control of a frame rate. Thus, magnetic resonance imaging at a variable frame rate is implemented.

According to the present invention as described above in detail, a magnetic resonance imaging system capable of adjusting a frame rate and a recording medium having recorded a program for causing a computer to implement such an imaging function can be implemented.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram of a system showing one example of an embodiment of the present invention.

FIG. 2 is a typical configurational diagram of a display/operation device.

FIG. 3 is a block diagram of a system showing one example of an embodiment of the present invention.

FIG. 4 is a diagram showing one example of a pulse sequence executed by the system shown in FIG. 1 or 3.

FIG. 5 is a diagram depicting one example of a pulse sequence executed by the system shown in FIG. 1 or 3.

FIG. 6 is a conceptual diagram of a k space and trajectories.

FIG. 7 is a conceptual diagram showing data collection at keyhole imaging.

FIG. 8 is a conceptual diagram illustrating a k space and a trajectory.

FIG. 9 is a conceptual diagram depicting a k space and a trajectory.

FIG. 10 is a conceptual diagram showing a k space and a trajectory.

FIG. 11 is a flowchart for describing the operation of the system shown in FIG. 1 or 3.

### DETAILED DESCRIPTION OF THE INVENTION

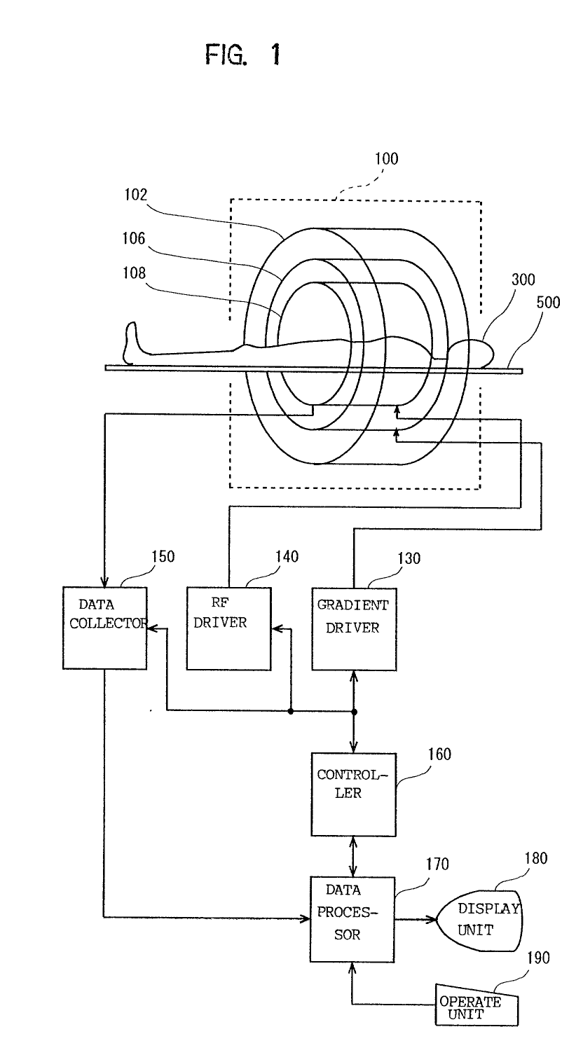

Embodiments of the present invention will hereinafter be described in detail with reference to the accompanying drawings. FIG. 1 shows a block diagram of a magnetic resonance imaging system or apparatus. The present system is one example of an embodiment of the present invention. One example of an embodiment related to a system of the present invention is illustrated based on the configuration of the present system.

As shown in FIG. 1, the present system has a magnetic system 100. The magnetic system 100 has a main magnetic field coil unit 102, a gradient coil unit 106 and an RF (radio frequency) coil unit 108. These coil units have substantially cylindrical shapes respectively and are placed coaxially with each other. A target 300 to be imaged, shot or photographed is placed on a cradle 500 in a substantially columnar internal bore of the magnetic system 100 and carried in and out by unillustrated conveying means.

The main magnetic field coil unit 102 forms a static magnetic field in the internal bore of the magnetic system 100. The direction of the static magnetic field is approximately parallel with the direction of the body axis of the target 300. Namely, the main magnetic field coil unit 102 forms a so-called horizontal magnetic field. The main magnetic field coil unit 102 is configured using a super conductive coil, for example. Incidentally, the main magnetic field coil unit 102 is not limited to the super conductive coil and may of course be configured using a normal conductive coil or the like.

The gradient coil unit 106 produces gradient magnetic fields each used for causing the intensity of the static magnetic field to have a gradient or slope. The produced gradient magnetic fields include three types of gradient magnetic fields of a slice gradient magnetic field, a read out gradient magnetic field and a phase encode gradient magnetic field. The gradient coil unit 106 has unillustrated 3-systematic gradient coils in association with these three types of gradient magnetic fields.

The RF coil unit 108 forms a high-frequency magnetic field for exciting a spin in a body of the target 300, in a static magnetic field space. Forming the high-frequency magnetic field is hereinafter called “transmission of an RF excitation signal”. Further, the RF coil unit 108 receives therein an electromagnetic wave, i.e., a magnetic resonance signal which produces the excited spin. The RF coil unit 108 has unillustrated transmitting and receiving coils. The transmitting coil and the receiving coil share the use of the same coil or make use of dedicated coils respectively.

A gradient driver 130 is connected to the gradient coil unit 106. The gradient driver 130 supplies a drive signal to the gradient coil unit 106 to generate a gradient magnetic field. The gradient driver 130 has unillustrated 3-systematic drive circuits in association with the 3 systematic gradient coils in the gradient coil unit 106.

An RF driver 140 is connected to the RF coil unit 108. The RF driver 140 supplies a drive signal to the RF coil unit 108 to transmit an RF excitation signal, thereby exciting the spin in the body of the target 300.

Further, a data collector 150 is connected to the RF coil unit 108. The data collector 150 takes in or captures a signal received by the RF coil unit 108 and collects it as digital data.

A controller 160 is connected to the gradient driver 130, the RF driver 140 and the data collector 150. The controller 160 controls the gradient driver 130 to data collector 150 respectively to execute shooting or imaging.

The output side of the data collector 150 is connected to a data processor 170. The data processor 170 is configured using a computer or the like, for example. The data processor 170 has an unillustrated. The memory stores a program and various data for the data processor 170 therein. The function of the present system is implemented by allowing the data processor 170 to execute the program stored in the memory.

The data processor 170 causes the memory to store the data captured from the data collector 150. A data space is defined in the memory. The data space forms a two-dimensional Fourier space. The data processor 170 transforms these data in the two-dimensional Fourier space into two-dimensional inverse Fourier form to thereby generate (reconstruct) an image for the target 300. The two-dimensional Fourier space is also called a “k space”.

The data processor 170 is connected to the controller 160. The data processor 170 is above the controller 160 in rank and generally controls it. Further, a display unit 180 and an operation or control unit 190 are connected to the data processor 170. The display unit 180 is made up of a graphic display or the like. The operation unit 190 comprises a keyboard or the like provided with a pointing device such as a track ball, a mouse or the like.

The display unit 180 displays a reconstructed image and various information outputted from the data processor 170. The operation unit 190 is operated by an operator and inputs various commands and information to the data processor 170. The operator controls the present system on an interactive basis through the display unit 180 and the operation unit 190.

For the sake of convenience of the execution of paracentesis or the like of the target 300 in parallel with the shooting or imaging of a tomogram of an affected area, the display unit 180 and the operation unit 190 are placed in the vicinity of the magnet system 100 and may preferably be operated in close proximity of the target 300. Alternatively, a display/operation device or unit prepared in addition to the display unit 180 and operation unit 190 on the operation room side may be placed in the neighborhood of the magnet system 100.

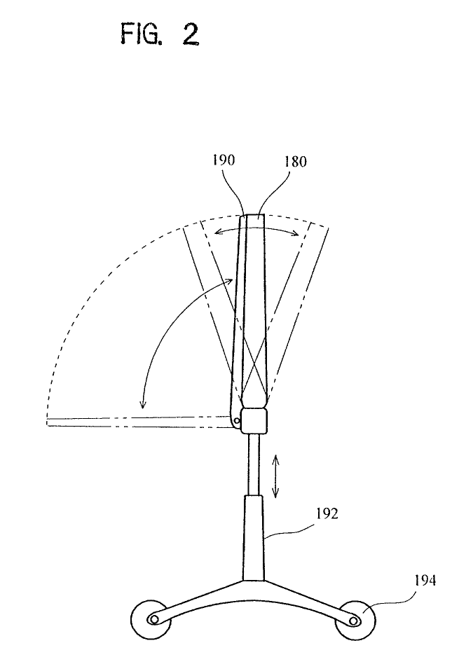

One such as shown in FIG. 2, for example is used as this type of display/operation device. The same drawing shows a side view of the display/operation device. As shown in the same drawing, the display/operation device has a display unit 180, an operation unit 190 and a stand 192.

The display unit 180 is configured using, for example, an LCD (Liquid Crystal Display), a flat CRT (Flat Cathode-ray Tube) or the like.

A portion for mounting the display unit 180 to the stand 192 serves as a hinge and can be rotated about it. Thus, the inclination of the display unit 180 can be controlled as indicated by chain double-dashed lines.

A portion for attaching the operation unit 190 to the stand 192 also serves as a hinge and is capable of being rotated about it. Thus, when the operation unit 190 is in use, it is horizontally opened and operated as indicated by chain double-dashed lines. On the other hand, when it is not in use, the operation unit 190 can be set so as not to be folded toward the display unit 180 and take up much space with respect to the display unit 180. The operation unit 190 is locked to the display unit 180 by an unillustrated lock mechanism when it is in a folded state.

The stand 192 is capable of expansion and contraction and hence can adjust the heights of the display unit 180 and the operation unit 190. The stand 192 has a caster 194 and facilitates the transfer of the display/operation device.

A portion comprising the magnet system 100 and the data collector 150 is one example of an embodiment illustrative of signal acquiring means employed in the present invention. A portion comprising the data processor 170 and the display unit 180 is one example of an embodiment illustrative of image generating means employed in the present invention. A portion comprising the display unit 180 and the operation unit 190 is one example of an embodiment illustrative of operating means employed in the present invention. The data processor 170 and the controller 160 show one example of an embodiment illustrative of control means employed in the present invention.

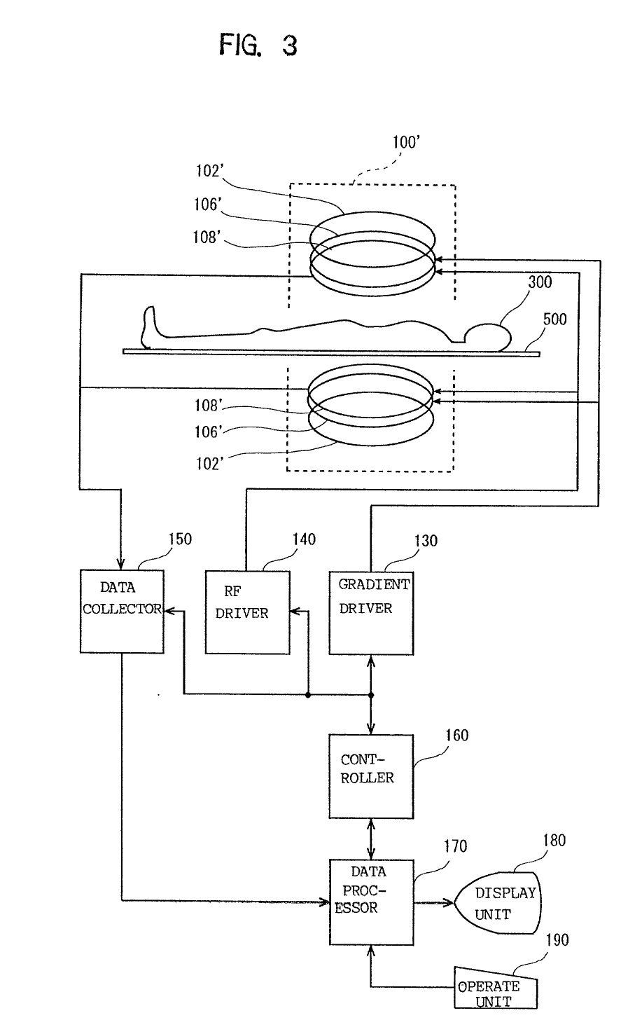

FIG. 3 shows a block diagram of another type of magnetic resonance imaging system or apparatus. The present system is one example of an embodiment of the present invention. One example of an embodiment related to a system of the present invention is shown based on the configuration of the present system.

The system shown in FIG. 3 has a magnet system 100′ different in principle or system from the system shown in FIG. 1. Those other than the magnet system 100′ are similar in configuration to those employed in the system shown in FIGS. 1 and 2. Similar parts are identified by the same reference numerals and their description will therefore be omitted.

The magnetic system 100′ has a main magnetic field magnet unit 102′, a gradient coil unit 106′ and An RF coil unit 108′. Any of these main magnetic field magnet unit 102′ and respective coil units comprises a pair of ones opposite to each other with a space interposed therebetween. Further, any thereof has a substantially disk-like shape and is placed so as to share the central axis. A target 300 is placed on a cradle 500 in an internal bore of the magnetic system 100′ and carried in and out by unillustrated conveying means.

The main magnetic field magnet unit 102′ forms a static magnetic field in the internal bore of the magnetic system 100′. The direction of the static magnetic field is approximately orthogonal to the direction of the body axis of the target 300. Namely, the main magnetic field magnet unit 102′ forms a so-called vertical magnetic field. The main magnetic field magnet unit 102′ is configured using a permanent magnet or the like, for example. Incidentally, the main magnetic field magnet unit 102′ is not limited to the permanent magnet and may of course be configured using a superconductive electromagnet or a normal conductive electromagnet or the like.

The gradient coil unit 106′ produces gradient magnetic fields each used for causing the intensity of the static magnetic field to have a gradient or slope. The produced gradient magnetic fields include three types of gradient magnetic fields of a slice gradient magnetic field, a read out gradient magnetic field and a phase encode gradient magnetic field. The gradient coil unit 106′ has unillustrated 3-systematic gradient coils in association with these three types of gradient magnetic fields.

The RF coil unit 108′ sends an RF excitation signal for exciting a spin in a body of the target 300 to a staticmagnetic field space. Further, the RF coil unit 108′ receives therein a magnetic resonance signal which produces the excited spin. The RF coil unit 108′ has unillustrated transmitting and receiving coils. The transmitting coil and the receiving coil share the use of the same coil or make use of dedicated coils respectively.

A portion comprising the magnet system 100′ and a data collector 150 is one example of an embodiment illustrative of signal acquiring means employed in the present invention. A portion comprising a data processor 170 and a display unit 180 is one example of an embodiment illustrative of image generating means employed in the present invention. A portion comprising the display unit 180 and an operation unit 190 is one example of an embodiment illustrative of operating means employed in the present invention. The data processor 170 and a controller 160 show one example of an embodiment illustrative of control means employed in the present invention.

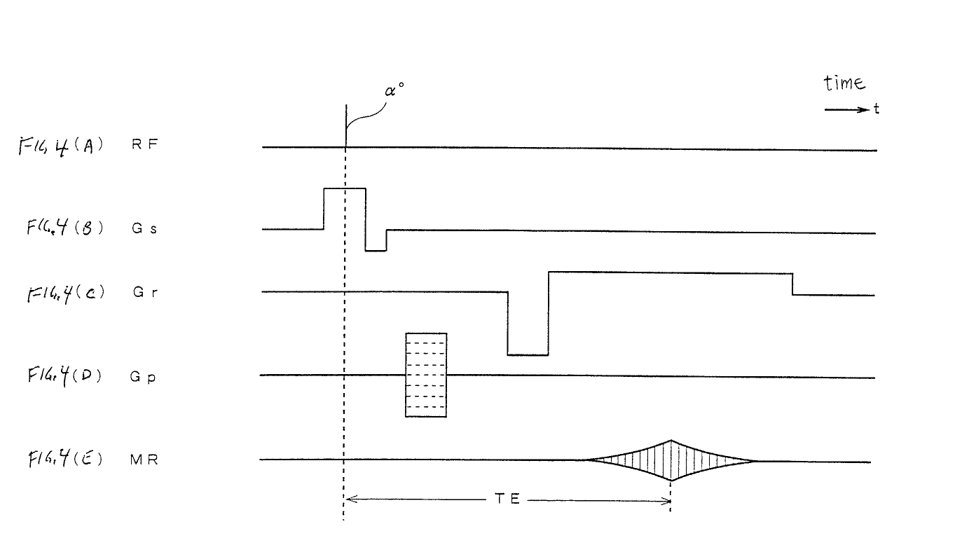

FIG. 4 shows one example of a pulse sequence used for magnetic resonance imaging. The present pulse sequence corresponds to a pulse sequence of a gradient echo (GRE) method.

Namely, (1) shows a sequence of a α° pulse for RF excitation employed in the GRE method. (2), (3), (4) and (5) similarly respectively show sequences of a slice gradient Gs, a read out gradient Gr, a phase encode gradient Gp and a gradient echo MR. Incidentally, the α° pulse is typified by a central signal. The pulse sequence proceeds from left to right along a time axis t.

As shown in the same drawing, α° excitation for the spin is carried out based on the α° pulse. A flip angle α° is less than or equal to 90°. At this time, the slice gradient Gs is applied to effect selective excitation on a predetermined slice.

After the α° excitation, the spin is phase-encoded based on the phase encode gradient Gp. Next, the spin is firstly dephased based on the read out gradient Gr. Next, the spin is rephased to generate a gradient echo MR. The signal strength of the gradient echo MR reaches a maximum after an echo time TE has elapsed since the excitation. The gradient echo MR is collected as view data by the data collector 150.

Upon the normal shooting or imaging, such a pulse sequence is repeated 64 to 512 times in a cycle TR (repetition on time). Each time it is repeated, the phase encode gradient Gp is changed and different phase encodes are carried out every time. Thus, view data for 64 to 512 views for filing in a k space can be obtained.

In order to improve the SNR (signal-to-noise ratio) of each view data, data for the same view is collected plural times and they are averaged. The number of times that the data for the same view is collected, is also called “NEX (Number of Exposure)”. Thus, the pulse sequence is repeated by the number of times obtained by multiplying 64 to 512 by NEX.

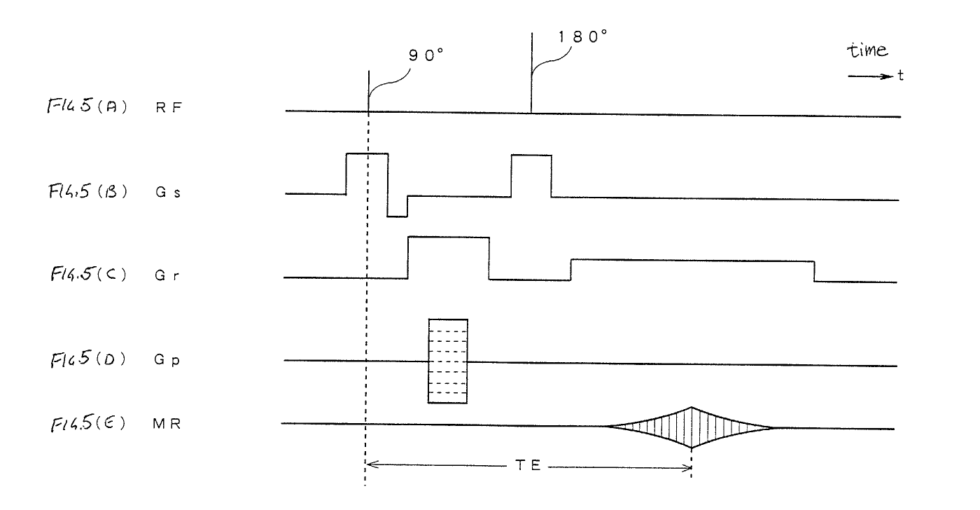

Another example of a pulse sequence for magnetic resonance imaging is shown in FIG. 5. The pulse sequence corresponds to a pulse sequence of a spin echo (SE) method.

Namely, (1) shows a sequence of a 90° pulse and a 180° pulse for RE excitation employed in the SE method. (2), (3), (4) and (5) similarly respectively show sequences of a slice gradient Gs, a read out gradient Gr, a phase encode gradient Gp and a spin echo MR. Incidentally, the 90° pulse and 180° pulse are typified by central signals. The pulse sequence proceeds from left to right along a time axis t.

As shown in the same drawing, 90° excitation for the spin is carried out based on the 90° pulse. At this time, the slice gradient Gs is applied to effect selective excitation on a predetermined slice. After a predetermined has elapsed since the 90° excitation, 180° excitation based on the 180° pulse, i.e., spin inversion is carried out. Even at this time, the slice gradient Gs is applied to effect selective inversion on the same slice.

The read out gradient Gr and the phase encode gradient Gp are applied during a period in which the 90° excitation and the spin reversal are carried out. The spin is dephased based on the read out gradient Gr. Further, the spin is phase-encoded based on the phase encode gradient Gp.

After the spin reversal, the spin is rephased based on the read out gradient Gr to produce a spin echo MR. The signal strength of the spin echo MR reaches a maximum after TE has elapsed since the 90° excitation. The spin echo MR is collected as view data by the data collector 150. Upon the normal imaging, such a pulse sequence is repeated 64 to 512 times in a cycle TR. Each time it is repeated, the phase encode gradient Gp is changed and different phase encodes are carried out every time. Thus, view data for 64 to 512 views for filling in a k space can be obtained.

In order to improve the SNR of each view data, data for the same view is collected plural times (NEX) and they are averaged. Thus, the pulse sequence is repeated by the number of times obtained by multiplying 64 to 512 by NEX.

Incidentally, the pulse sequence used for imaging is not limited to the GRE method or SE method. The pulse sequence may be other suitable techniques such as an FSE (Fast Spin Echo) method, a fast recovery FSE (Fast Recovery Fast Spin Echo) method, echo planar imaging (EPI), etc.

The data processor 170 transforms the view data in the k space into two-dimensional inverse Fourier form to thereby reconstruct a tomogram for the target 300. The reconstructed image is stored in its corresponding memory and displayed on the display unit 180.

Such imaging is sequentially carried out upon real-time imaging, and reconstructed images are displayed one after another. A frame rate for the display of each image is principally determined according to the time required to acquire view data enough to reconstruct the image. The more the time becomes short, the more the frame rate is improved.

Thus, the frame rate can be improved by reducing NEX. A reduction in the number of views allows an improvement in frame rate. Shortening TR can yield an improvement in frame rate. Further, the shortening of TE also brings about an effect for the purpose of an improvement in frame rate through the use of the shortening of TR.

Incidentally, if the intensity of the phase encode gradient is adjusted according to the reduction in the number of views, FOV (Field of View) can be kept identically or uniformly. However, spatial resolution is reduced. When the intensity of the phase encode gradient is not controlled according to the reduction in the number of views, the spatial resolution can be kept uniformly. However, the FOV is reduced. When, in this case, the region of interest (ROI) falls outside the FOV, the phase encode gradient is offset, whereby the position of the FOV can be adjusted so as to include the ROI.

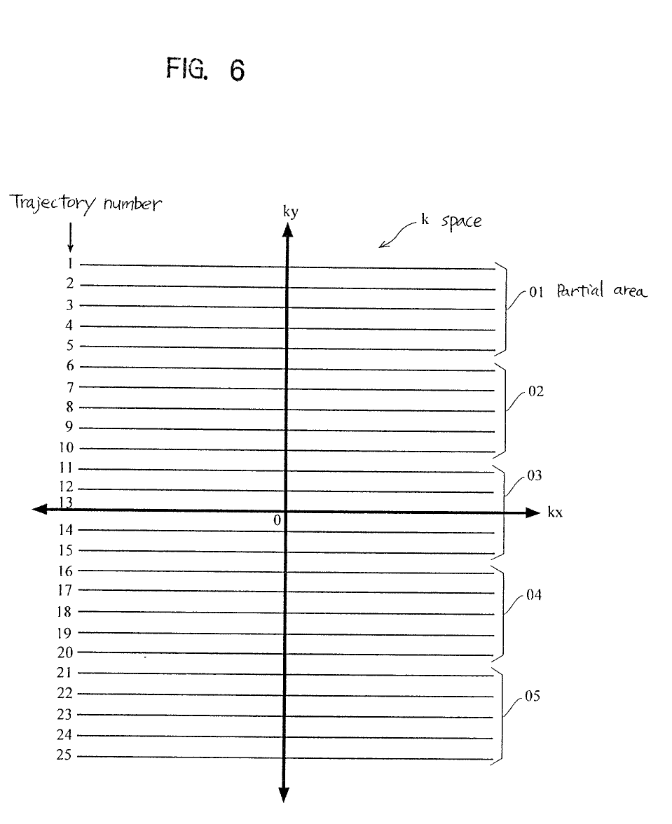

A description will next be made of trajectories for collecting view data in a k space. FIG. 6 shows the concept of trajectories in a k space. The k space has two coordinate axes kx and ky orthogonal to each other. Kx indicates a frequency axis and ky indicates a phase axis. The origins of both coordinate axes are located in the center of the k space.

The trajectories correspond to a plurality of straight lines which are parallel with the frequency axis ks and having intervals in the direction of the phase axis ky. The position of each trajectory on the phase axis ky corresponds to the amount of phase encode. The number of the trajectories is equal to the number of views. Ascending numbers are respectively applied to the trajectories from the positive maximum value of the phase encode to the negative maximum value thereof. For convenience of description, the number of the trajectories is set to 25 in the present embodiment. Namely, one set of data for filling in the k space by 25 views is supposed to be collected. Data are collected in a predetermined order every trajectories. The reconstruction of each image is carried out using one set of data.

The k space is partitioned into five partial areas, for example. In the same drawing, the partial area 03 is a partial area which includes the coordinate origin of the k space. The partial areas 02 and 04 are areas which respectively adjoin the outsides of the partial area 03 as viewed in the phase axis direction. The partial areas 01 and 05 are areas which respectively adjoin the outsides of the partial areas 02 and 04 as viewed in the phase axis direction. Incidentally, the number of the partitions is not limited to five and may suitably be set. The partial area 03 is also called a central area, and the partial areas 01, 02, 03 and 05 are also called peripheral areas.

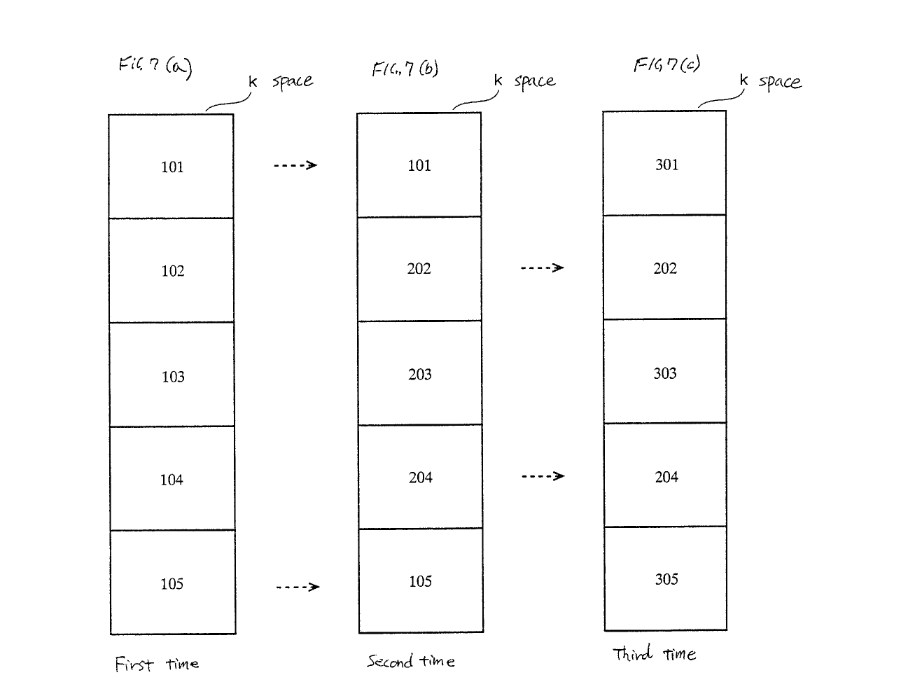

When the real-time imaging is carried out, data are collected with respect to the so-partitioned k space according to a procedure shown in FIG. 7 by way of example. Firstly, the first scan is done to collect data in all the partial areas respectively as shown in the same drawing (a)

An image is reconstructed based on one set of view data collected in the k space. The contrast of the reconstructed image is determined according to view data collected in the central area 03. On the other =hand, view data in the peripheral areas 01, 02, 04 and 05 determine spatial resolution of the reconstructed image. Therefore, the reconstructed image substantially shows the time phase of the target 300 at the time that the data is collected in the central area 03. Such an image is displayed on the display unit 180 and stored in its corresponding memory.

Upon the second scan, only the view data which belongs to the central area 03 and the view data which belong to the peripheral areas 02 and 04, are collected. Thus, only the view data which belong to the central area 03 and the peripheral areas 02 and 04, are updated as shown in FIG. 7(b).

An image is reconstructed based on the thus-partially updated data and the firstly collected view data in the peripheral areas 01 and 05. This image shows the time phase of the target 300 at the time that the data is collected in the central area 03 by the second scan. Such an image is displayed on the display unit 180 and stored in the memory.

Upon the third scan, only the view data which belongs to the central area 03 and the view data which belong to the peripheral areas 01 and 05, are collected. Thus, only the view data which belong to the central area 03 and the peripheral areas 01 and 05, are updated as shown in FIG. 7(c).

An image is reconstructed based on the so-partially updated data, and the view data in the peripheral areas 02 and 04, which have been collected secondly. This image shows the time phase of the target 300 at the time that the data is collected in the central area 03 by the third scan. Such an image is displayed on the display unit 180 and stored in the memory.

The scan is repeated according to procedures similar to the second and third time. Thus, the collection of the data is carried out in twice in the areas other than the central area 03 in the k space. Therefore, shooting or imaging can be done in an hour equivalent to ⅗ of the time necessary for the first time from the second time up. This imaging is also called keyhole imaging.

Assuming that the ratio of the central area to the entire k space is defined as a and the partitioned number of peripheral areas is defined as n, the ratio of an imaging time necessary for the second time or later to an imaging time necessary for the first time is given by the following equation.

$$A = a + \frac{2 ( 1 - a )}{2 n} \qquad ( 1 )$$

As the ratio a of the central area decreases and the partitioned number n of peripheral areas increases, the ratio A is reduced. Since the inverse number of the imaging time corresponds to a shooting or imaging frame rate, the frame rate is improved as the central area decreases and the partitioned number of peripheral areas increases. In the example of FIG. 7, a equals ⅕, n equals 2, and A becomes ⅗ in the equation. Incidentally, there is no need to set the partition of the k space into the peripheral areas to equal partition.

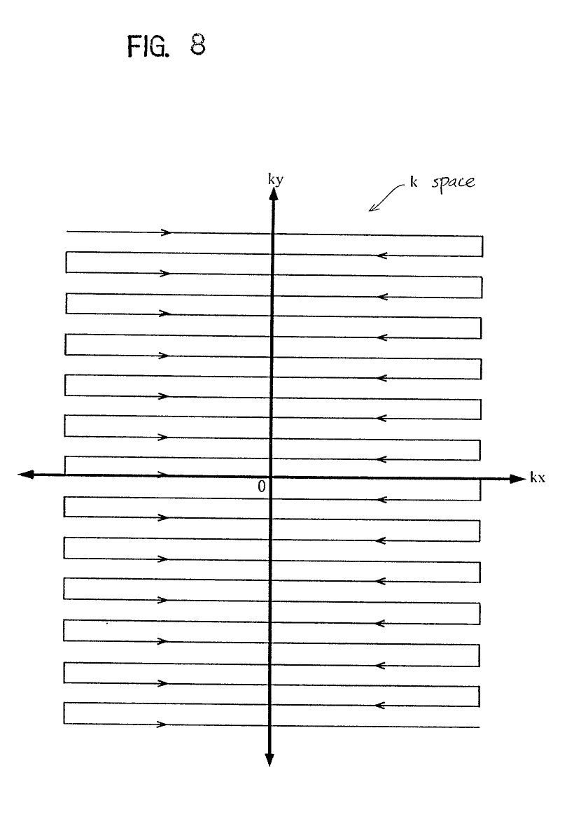

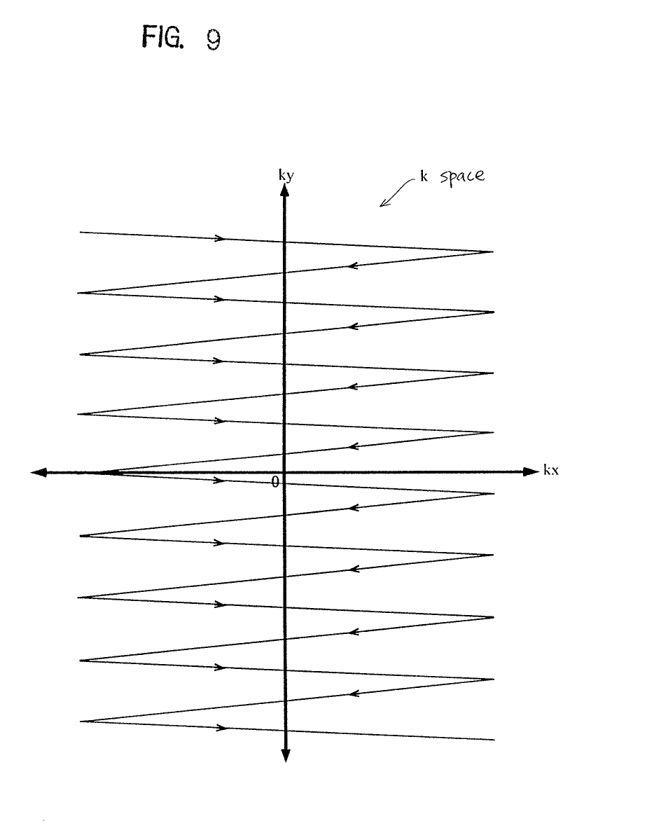

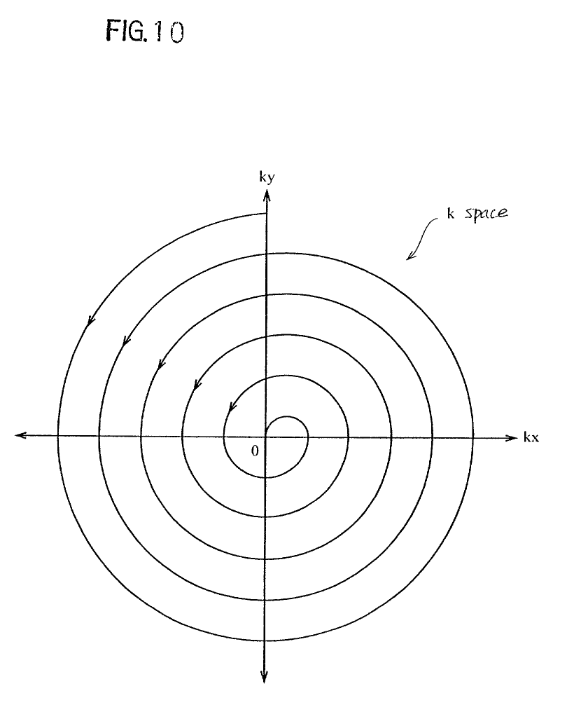

When the imaging is carried out by EPI, the collection of data in the k space is done as follows: As shown in FIG. 8 by way of example, the data is collected along a single trajectory for sweeping the k space on a so-called one-stroke drawing basis. The sweeping of the k space can also be carried out along such a trajectory as shown in FIG. 9 by way of example according to the way of giving the phase encode gradient and read out gradient. Further, the sweeping can also be carried out along such a trajectory as shown in FIG. 10.

Upon such imaging, the imaging time is proportional to the number of turnovers of the trajectory and the number of returns thereof. Accordingly, the frame rate can be increased as the number of turnovers of the trajectory and the number of returns thereof decrease. The number of turnovers of the trajectory and the number of turns thereof correspond to a kind of the number of views for signal collection.

The number of the turnovers can be adjusted according to the number of switchovers of the phase encode gradient. The number of the turns can be adjusted according to the numbers of switchovers of the phase encode gradient and the read out gradient. In this case, a method of reducing spatial resolution in place of a non-change in FOV and a method of reducing FOV in place of a non-change in spatial resolution are known according to the way of selecting gradient magnetic fields.

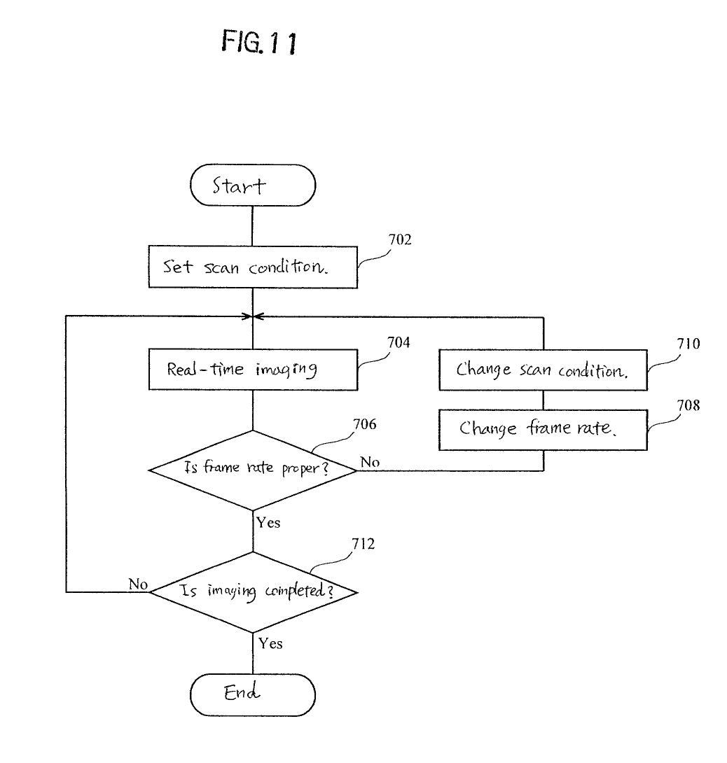

A description will next be made of control on the frame rate for real-time imaging by the present system. FIG. 11 shows a flow chart for describing the operation of the present system at the real-time imaging. As shown in the same drawing, scan conditions are first set in step 702. The setting of the scan conditions is carried out by the operator through the use of the operation unit 190. The scan conditions include a setting condition for acquiring a magnetic resonance signal, e.g., the type of pulse sequence, FOV, the number of views, NEX, TR, TE, etc.

When such keyhole imaging as shown in FIG. 7 is performed, the size a of the central area and the partitioned number n of peripheral areas constitute the scan conditions. When EPI shown in FIGS. 8 through 10 is carried out, the number of turnovers of the trajectory and the number of turns thereof also constitute one scan condition.

Next, the real-time imaging is carried out in step 704. Consequently, a real-time tomogram of the target 300 is displayed on the display unit 180. A frame rate for image display is determined according to the scan conditions.

When the scan conditions, i.e., the number of views: 64, NEX: 2 and TR: 10 ms according to the GRE method, the frame rate:

$$\frac{1000}{64 \times 2 \times 10} = 0.78 {sec}^{- 1} \qquad ( 2 )$$

The frame rate is obtained as expressed above.

In step 706, the operator determines whether the frame rate for the image display is proper. If the frame rate is found not to be proper, then the frame rate is changed in step 708.

The change in frame rate is carried out under the operation of an up-down switch or the like, for example. The up-down switch may be a virtual switch in which GUI (Graphic User Interface) is operated by a pointing device. Alternatively, the up-down switch may be specified by the direction of rotation of a track ball. The up-down switch or the track ball is operated in an up direction to thereby designate or specify a rise in frame rate and operated in a down direction to thereby specify a reduction in frame rate. The change in frame rate may of course be carried out based on a command input or a numeric input given from a keyboard.

In step 710, the scan conditions are changed according to the change in frame rate. The change in scan conditions is performed by the data processor 170. The changed scan condition is NEX, for example.

When it is desired to increase the frame rate, NEX is reduced. Setting NEX to 1, for example, yields a double rise in frame rate. When the frame rate is reduced, NEX is increased. Setting NEX to 3 lowers the frame rate to ⅔, for example.

The scan condition to be changed is not limited to NEX and may be the number of views, TR, TE or a combination of these. In the case of the keyhole imaging, the scan condition may be the size a of the central area or the partitioned number n of peripheral areas. In the case of EPI, the scan condition may be the number of turnovers of the trajectory and the number of turns thereof. Which scan condition should be changed, is determined in advance. Alternatively, the operator may specify the scan condition on a case-by-case basis.

In step 704, the real-time imaging is done according to the so-changed scan condition. A tomogram is displayed based on a new frame rate. Such control on the frame rate is performed until a desired frame rate is obtained. When the frame rate is proper, it is determined in step 712 whether the imaging is completed. When the imaging is found not to be completed, the present system returns to step 704 and continues the above-described operation. When it is necessary to control or adjust the frame rate during imaging, the frame rate can be adjusted at any time in the above-described manner.

The frame rate most suitable for the conduction of operation can be obtained in this way. The operator performs an operation such as paracentesis or the like while observing the position and state of an affected part on a real-time tomogram at the suitable frame rate. Incidentally, an image to be displayed is not limited to an image placed during the execution of operation and may be a tomogram of a joint or the like placed during bending exercises.

A program for allowing the data processor 170 (computer) to implement the function of the present system such as described above is recorded in a recording medium readable by the computer. The recording medium readable by the computer may be any of a magnetic recording medium, an optical recording medium, a magnetooptic recording medium and a recording medium using a semiconductor. Incidentally, the recording medium is synonymous with a storage medium in the present specification.

Many widely different embodiments of the invention may be configured without departing from the spirit and the scope of the present invention. It should be understood that the present invention is not limited to the specific embodiments described in the specification, except as defined in the appended claims.

1. A magnetic resonance imaging system comprising:
a signal acquiring device for acquiring a magnetic resonance signal;
an image generating device for generating an image, based on the magnetic resonance signal;
an operating device for controlling a frame rate of the image; and
an adjusting device for adjusting a signal acquiring condition of said signal acquiring device according to the frame rate.

2. The magnetic resonance imaging system according to claim 1, wherein the signal acquiring condition is the number of times that a magnetic resonance signal for the same view is acquired.

3. The magnetic resonance imaging system according to claim 1, wherein the signal acquiring condition is the number of views for acquiring a magnetic resonance signal.

4. The magnetic resonance imaging system according to claim 1, wherein the signal acquiring condition is a cycle period of a pulse sequence for acquiring a magnetic resonance signal.

5. The magnetic resonance imaging system according to claim 1, wherein the signal acquiring condition is an echo time for a magnetic resonance signal.

6. The magnetic resonance imaging system according to claim 1, wherein the signal acquiring condition is the size of a single central area at the time that a k space is partitioned into the single central area and a plurality of peripheral areas and data is updated in the central area with frequency higher than the peripheral areas.

7. The magnetic resonance imaging system according to claim 1, wherein the signal acquiring condition is the partitioned number of peripheral areas at the time that a k space is partitioned into a single central area and a plurality of peripheral areas and data is updated in the central area with frequency higher than the peripheral areas.

8. The magnetic resonance imaging system according to claim 1, wherein the signal acquiring condition is the number of turnovers of a trajectory in a k space and the number of turns thereof at the time that a magnetic resonance signal is acquired according to a pulse sequence for echo planar/imaging.

9. A recording medium having recorded therein programs for causing a computer to execute a signal acquiring function for acquiring a magnetic resonance signal;
an image generating function for generating an image, based on the magnetic resonance signal;
an operating function for controlling a frame rate of the image; and
an adjusting function for adjusting a signal acquiring condition for said signal acquiring function according to the frame rate,
said programs being recorded therein so as to be readable by the computer.

10. The recording medium according to claim 9, wherein the signal acquiring condition is the number of times that a magnetic resonance signal for the same view is acquired.

11. The recording medium according to claim 9, wherein the signal acquiring condition is the number of views for acquiring a magnetic resonance signal.

12. The recording medium according to claim 9, wherein the signal acquiring condition is a cycle period of a pulse sequence for acquiring a magnetic resonance signal.

13. The recording medium according to claim 9, wherein the signal acquiring condition is an echo time for a magnetic resonance signal.

14. The recording medium according to claim 9, wherein the signal acquiring condition is the size of a single central area at the time that a k space is partitioned into the single central area and a plurality of peripheral areas and data is updated in the central area with frequency higher than the peripheral areas.

15. The recording medium according to claim 9, wherein the signal acquiring condition is the partitioned number of peripheral areas at the time that a k space is partitioned into a single central area and a plurality of peripheral areas and data is updated in the central area with frequency higher than the peripheral areas.

16. The recording medium according to claim 9, wherein the signal acquiring condition is the number of turnovers of a trajectory in a k space and the number of turns thereof at the time that a magnetic resonance signal is acquired according to a pulse sequence for echo planar/imaging.

17. A magnetic resonance imaging method comprising the steps of:
acquiring a magnetic resonance signal;
generating an image based on the magnetic resonance signal;
controlling a frame rate of the image; and
adjusting a signal acquiring condition according to the frame rate.
